(19) United States
(12) Patent Application Publication
(10) Pub. No.: US 2004/0034529 A1
(43) Pub. Date: Feb. 19, 2004

(54) Multifunction printer that converts and prints voice data

(76) Inventor: Howard Gaines Hooper III, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/217,513

(22) Filed: Aug. 14, 2002

(51) Int. Cl. G10L 13/08

(52) U.S. Cl. 704/260

(57) ABSTRACT

A method, program product, and printer, for recording voice data at a printer or fax or copier device, the method comprising the steps of: selecting to print voice data; porting the voice data to a voice recognition module; converting the voice data to digital data; and converting the digital data to print data.

### FIELD OF THE INVENTION

The present invention relates generally to the field of printing and/or multifunction printing devices.

### BACKGROUND OF THE INVENTION

The present invention is directed to the problem and inconvenience entailed by requirements to transcribe voicemails and other voice data in an efficient and timely manner.

### SUMMARY OF THE INVENTION

Briefly, the present invention comprises in one embodiment, a method of recording voice data at a printer or fax or copier device, comprising the steps of: selecting to print voice data; porting the voice data to a voice recognition module; converting the voice data to digital data; and converting the digital data to print data.

In a further embodiment of the present invention, a printer is disclosed comprising: an input module for receiving voice data; a voice recognition converter for converting received voice data to digital data; a data modem for converting non-voice data to digital data; a printer formatter for converting the digital data to print data; and a print engine for printing print data.

In a yet further embodiment of the present invention, a program product for recording voice data at a printer or fax or copier device is provided, comprising machine-readable program code to perform the following method steps: receiving voice data; selecting to print the voice data; converting the voice data to digital data; and converting the digital data to print data.

In a yet further embodiment of the present invention, a device is disclosed for printing voice data at a printer or fax or copier device, comprising: means for receiving voice data; means for converting received voice data to digital data; means for converting non-voice data to digital data; means for converting the digital data to print data; and means for printing the print data.

### BRIEF DESCRIPTION OF THE DRAWINGS

FIG. 1 is a schematic block diagram of an embodiment of the present invention.

FIG. 2 is a flowchart of an embodiment for implementing the present invention.

FIG. 3 is a perspective drawing of a multifunction printer in accordance with the present invention.

### DETAILED DESCRIPTION OF THE EMBODIMENTS

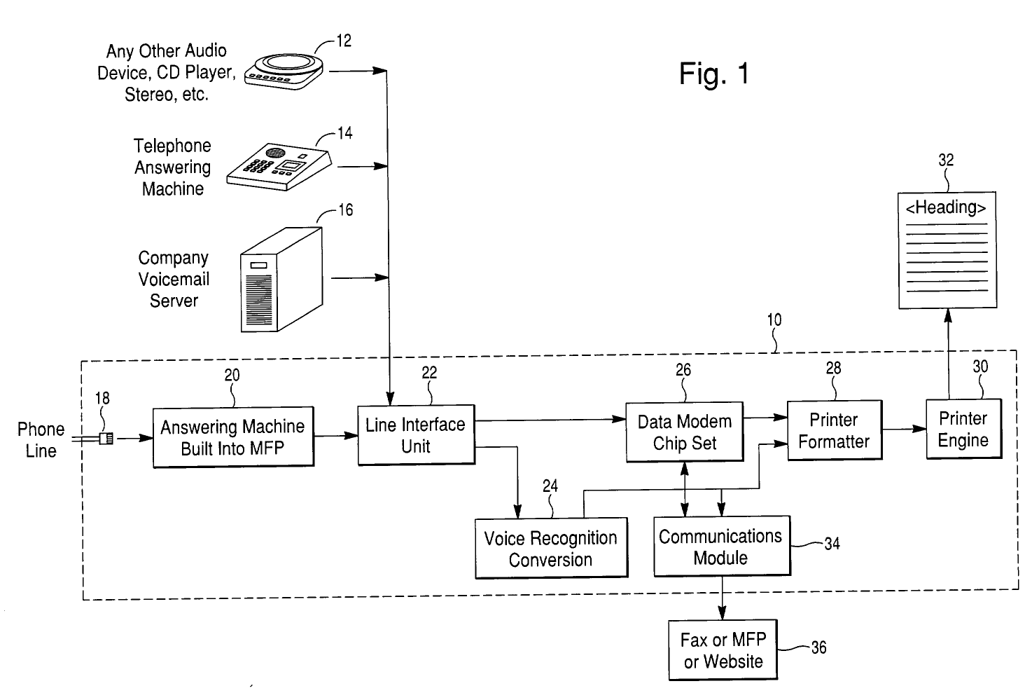

Referring now to FIG. 1, one embodiment for the present invention comprises a printer or a fax or a copier device or a multifunction printer 10 modified to process voice data. There are a variety of sources of voice data which may provide inputs to the device 10. By way of example, an voice device 12 such as a CD player or a stereo could provide an input. Likewise, a telephone answering machine 14 may provide an input to the device 10. Likewise, a company voicemail server 16 may provide an input to the device 10. Alternatively or in addition, the device 10 could have its own telephone and/or voicemail capability and voice data could be brought in by means of a telephone line 18. For the embodiment where the device has its own telephone capability, the telephone line would be applied to an answering machine 20 which may be built into the device 10 and designed to receive RJ-11 or other telephone input. Note that alternatively or in addition, the input module 20 would be provided to receive wireless data. By way of example, the input module could comprise a wireless antenna or photosensor/LED transmitter. Alternatively or in addition, the input module could comprise a standard cable I/O jack such as a USB or RS-232 jack. If a wireless input module is included, this module could be implemented using variety of wireless protocols, such as Bluetooth for example, to facilitate communication using radio-frequency waves. Alternatively, the input module could include an IR protocol and an IR receive/transmit chip. By way of example, a variety of IR receive/transmit chips are available to implement SIR and FIR protocols. It should be noted that if the present invention is to be implemented for IR communication, then an infrared transmit/receive diode or other appropriate IR receiver/transmitter may be utilized.

The stored voice data from the device 20 or any of the devices 12, 14, or 16 would then be applied to a line interface unit 22. The line interface unit 22 functions first to determine if the incoming data is voice data or non-voice data. The determination will be made, by way of example but not by way of limitation, by sampling the signal and determining what analog frequency spectrums are represented. Additionally, the line interface unit 22 would perform various other housekeeping tasks such as modulating the voltage from the answering machine 20 or any of the other devices 12, 14, or 16 in order to provide a substantially clean voltage signal with noise minimized.

If the data received by the line interface unit 22 is determined to be voice data, then this voice data is ported to a voice recognition module 24. Voice recognition modules are well known in the art and any of a variety of the different voice recognition modules may be utilized to implement the present invention. The voice recognition module 24 converts the voice data to digital data.

The non-voice data from the line interface unit 22 is ported directly to a data modem 26 for conversion to binary data and for formatting of the sets of pulses. Such data modem chip sets are well known in the art and any of a variety of such data modems may be utilized to implement the present invention.

The non-voice digital output from the data modem chip set 26 and the digital data from the voice recognition conversion 24 are then applied to a printer formatter 28 which operates to translate the data into a print language such as PCL, PostScript, Raster graphics, or any of a variety of other printer languages.

Optionally, source information such as a calling telephone number, a called telephone number, the length of the telephone call or fax, the date and time of the telephone call or fax, and other convenient or desired source information for the incoming data may then be added in a header for the print data. Note that fax data will typically include such data in the signal, which may be recognized by means of delimiters in the data. For voicemail that is to be transcribed, the indication to transcribe the voicemail data may be used to automatically append pertinent source data to the voice mail as voice data or digital data. If the source data is provided as voice data, if may be set apart and recognized by means of some form of delimiters such as the occurrence of a predetermined tone at the beginning and end of the source data. Alternatively, the source data could be obtained from Caller ID or other comparable signals appended to the voice signal. Alternatively, source data such as the time and date may be obtained from a real-time clock at the printer formatter 28.

The header may take a variety of different forms. The term “header” is intended to be interpreted in a generic sense to encompass an area at a predetermined location in the document that contains the transcribed data. This location could be at the beginning of the document, the end of the document, or at various predetermined locations within the document. By way of example but not by way of limitation, the header may comprise a graphic read from a memory, such as a flash memory programmable RAM, and appended to the predetermined location or locations within the document. Firmware would then map the source data, which may, in one embodiment, be recognized by means of one or more different types of delimiters or XML designations, to designated locations within the graphic.

Finally, the output from the printer formatter 28 is applied to a printer engine 30 for printing the voice or other data on paper 32 or another convenient medium.

Optionally, the digital voice data from the voice recognition conversion module 24 and/or the digital non-voice data from the data modem chip set 26 may be sent, with or without the source information and/or header, via a communications module 34, to another fax machine or multifunction printer or a web site, represented by the block 36.

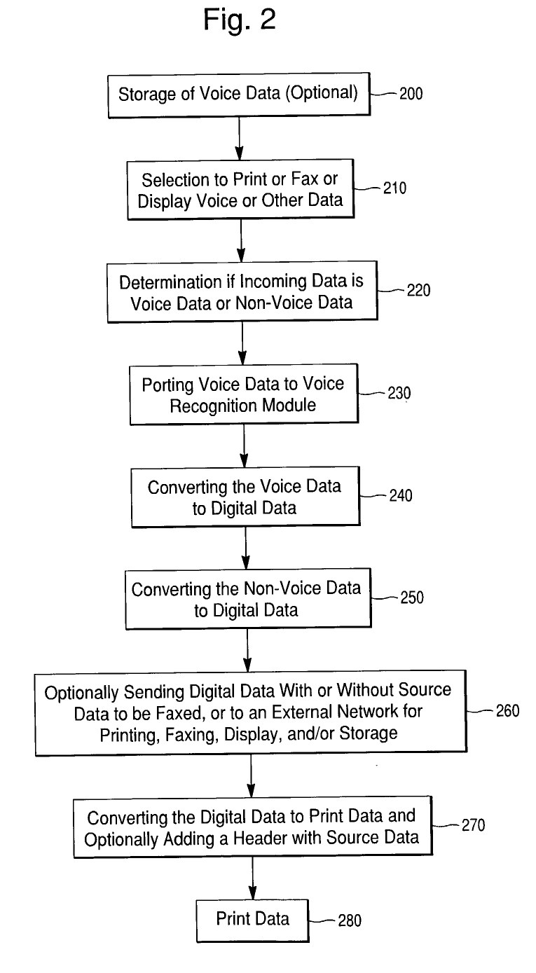

Referring now to FIG. 2, a flowchart of an embodiment for implementing the present invention is shown. The block 200 represents an optional storage operation for the voice data. As noted previously, such storage may occur by means of any of the voice devices 12, 14, or 16, or via the answering machine 20, or via any other convenient method.

Block 210 represents a selection by a user, or an automatic selection of the option to print, or fax, or display voice or fax or other data. This selection may be performed automatically, or may be accomplished by means of push buttons, or clickable icons or other selectable items on a graphical user interface on the device 10, or by a voice command or tone or pulse command, or by any other convenient method. It should be noted that this selection may be accomplished remotely by a user from a PC or PDA or other convenient device, with the selection designation ported into the device 10 via the communications module 34.

Referring to block 220, a determination is made as to whether the incoming data is voice data or non-voice data. By way of example, non-voice data may comprise fax data being received on the telephone line 18.

Referring to block 230, if the data is determined to be voice data, then it is ported to the voice recognition module. In block 240 the voice data is converted to digital data.

Referring to block 250, the non-voice data is converted to digital data.

Referring to block 260, optionally or in addition, the voice digital data from block 240 and/or non-voice digital data from block 250 and optional source information and/or a header may be transmitted by means of the communications module 34 to another fax machine or multifunction printer or to a web site 36 or other device type for processing or storage. Note that the communications module could use any convenient I/O protocol, including TCP/IP protocol, USB protocol, or Bluetooth for example.

Referring to block 270, the resulting digital pulse data is converted to print data such as PCL, or Postscript by way of example. Additionally, a header made with source information may optionally be added to this printer data, as noted above.

Referring to block 280, this formatted print data and header data may then be printed.

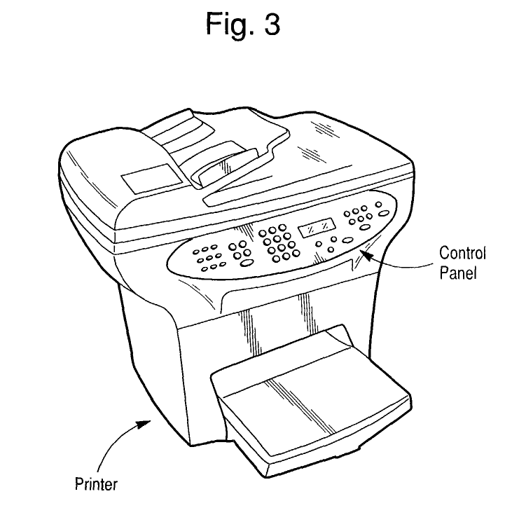

Referring now to FIG. 3, there is shown an example of a multifunction printer device that has been modified to print out voice messages by adding a memory device for storing voice data and/or fax data, as well as the various chips required to translate the recorded message into text and then to convert that translated text into appropriate printer language for output to the printer engine. In an embodiment, one of the buttons on the control panel on the front of the MFT device would initiate a voice-to-be-printed-as-text command. Additionally, if an answering machine is integrated into the unit, then a button for a record option may be added.

Accordingly, the present invention allows full documentation of important voicemails without the user being required to transcribe the voicemail. By way of example but not by way of limitation, the user may be given an option during the “erase message” prompt as to whether or not to print the voicemail.

It should be noted that the optional header with the source information may be utilized to authenticate the voice data with a date stamp, or a caller ID, and telephone number called from, by means of encryption, digital certificates, or other means.

The foregoing description of an embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of recording voice data at a printer or fax or copier device, comprising the steps of:
selecting to print voice data;
porting the voice data to a voice recognition module;
converting the voice data to digital data; and
converting the digital data to print data.

2. The method as defined in claim 1, wherein the porting step comprises porting the voice data from one of a voice device, telephone, or voicemail server.

3. The method as defined in claim 1, further comprising determining whether data is voice data or non-voice data and only porting the data to the voice recognition module if the data is voice data.

4. The method as defined in claim 3, further comprising converting non-voice data to digital data.

5. The method as defined in claim 1, further comprising:
obtaining source data for the voice data; and
adding a header containing the source data to the digital data.

6. The method as defined in claim 1, further comprising faxing the digital data.

7. The method as defined in claim 1, further comprising transmitting the digital data to a location in a network.

8. The method as defined in claim 1, further comprising the step of transmitting the digital data to a web site.

9. The method as defined in claim 1, further comprising the step of printing the print data.

10. A printer comprising:
an input module for receiving voice data;
a voice recognition converter for converting received voice data to digital data;
a data modem for converting non-voice data to digital data;
a printer formatter for converting the digital data to print data; and
a print engine for printing print data.

11. The printer as defined in claim 10, further comprising: a line interface unit for determining if data from the input module is voice data or non-voice data and sending only voice data to the voice recognition converter, and sending non-voice data directly to the data modem.

12. The printer as defined in claim 10, further comprising a communications module for transmitting non-voice digital data from the voice recognition converter to an external network.

13. The printer as defined in claim 10, wherein the input module receives signal data from a telephone line or wireless, and further includes memory for storing the received signal data.

14. A program product for recording voice data at a printer or fax or copier device, comprising machine-readable program code to perform the following method steps:
receiving voice data;
selecting to print the voice data;
converting the voice data to digital data; and
converting the digital data to print data.

15. The program product as defined in claim 14, further comprising code to perform the step of determining whether data is voice data or non-voice data and only using a voice recognition conversion if the data is voice data.

16. The program product as defined in claim 15, further comprising code for converting the non-voice data to digital.

17. The program product as defined in claim 14, further comprising code for performing the steps of:
obtaining source data for the voice data; and
adding a header containing the source data to the voice digital data.

18. The program product as defined in claim 14, further comprising code to perform the step of printing the print data.

19. The program product as defined in claim 14, further comprising the code for performing the step of transmitting the voice digital data to a different location in a network.

20. A device for printing voice data at a printer or fax or copier device, comprising:
means for receiving voice data;
means for converting received voice data to digital data;
means for converting non-voice data to digital data;
means for converting the digital data to print data; and
means for printing the print data.
